(19) United States
(12) Patent Application Publication
(10) Pub. No.: US 2005/0283656 A1
(43) Pub. Date: Dec. 22, 2005

(54) System and method for preserving a user experience through maintenance of networked components

(75) Inventors: David W. Baumert, Sammamish, WA (US); Wistar D. Rinearson, Redmond, WA (US)

Correspondence Address: SHOOK, HARDY & BACON L.L.P., 2555 GRAND BOULEVARD, KANSAS CITY, MO, 64108-2613, US

(73) Assignee: Microsoft Corporation, Redmond, WA (US)

(21) Appl. No.: 10/870,949

(22) Filed: Jun. 21, 2004

(51) Int. Cl. G06F 11/00

(52) U.S. Cl. 714/8

(57) ABSTRACT

A system and method are provided for preserving a user experience by maintaining a network component. The method includes continuously monitoring the network component for an abnormality. Upon detecting an abnormality, the method includes querying the network for resources. The method additionally includes implementing alternative network resources to compensate for the abnormality in order to preserve a user experience. The system may include a self monitoring component for monitoring operation of the network component and detecting an abnormality. The system additionally includes a resource location and negotiation module for querying a network to locate and negotiate for resources for compensating for the abnormality upon detection of the abnormality. The system may also include a reporting module for providing a user with an abnormality report.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to maintenance of network components and in particular to a distributed platform for facilitating self maintenance of each network component.

### BACKGROUND OF THE INVENTION

With widespread adoption of wireless networks and the proliferation of networked components, it is desirable to create products that intelligently take advantage of these networking capabilities. In particular, intelligent features of networked components may be able to utilize networking capabilities to improve individual performance for each component. Currently, in peer-to-peer environments, the malfunctioning of individual network components is typically detected by the user of the individual networked component. Other networked components and users of other networked components are unaware of the malfunctions.

With regard to networking options, one currently available networking option is Bluetooth, which is a short-range radio technology aimed at simplifying communications among Internet devices and between Internet devices and other computers. Bluetooth uses short-range radio links to replace cables between computers and connected units. Using Bluetooth and other similar technologies, mobile devices can communicate with one another when the devices are within a pre-determined distance from one another.

Other technologies that facilitate communications between devices include wireless local area networks (WLANs), wireless application protocol (WAP), and Infrared Technologies such as IrDA-Data. All of these technologies are capable of simplifying wireless communications between devices and can be used optimally in different environments. For example, WLANs are LAN protocols modulated on carrier waves. WLANs can handle greater data throughput than Bluetooth and are generally server-based, whereas Bluetooth technologies are generally peer-to-peer. WAP is a communications protocol for mobile phones intended to extend available Internet-based services. Furthermore, conventional networks that are not wireless can benefit from more advanced technologies.

A solution is needed for taking advantage of networking capabilities for detecting and responding to malfunctions and abnormalities within a network component and for detecting and responding to network outages, thereby increasing the networked system's ability to preserve the quality of the user experience when abnormalities or malfunctions occur. The solution should operate in conjunction with networking standards and resources in a uniform manner in order to assess and maintain platform functionality.

### BRIEF SUMMARY OF THE INVENTION

Embodiments of the present invention include a method for preserving a user experience by maintaining a network component. The method includes continuously monitoring the network component for an abnormality. Upon detecting an abnormality, the method includes querying the network for resources. The method additionally includes implementing alternative network resources to compensate for the abnormality in order to preserve a user experience.

In additional aspect of the invention, a component maintenance system is provided for preserving a user experience. The component maintenance system includes a self monitoring component for monitoring operation of the network component and detecting an abnormality. The system additionally includes a resource location and negotiation module for querying a network to locate and negotiate for resources for compensating for the abnormality upon detection of the abnormality. Finally, the system includes a reporting module for providing a user with an abnormality report.

In yet a further aspect of the invention, a network maintenance system is provided for preserving a user experience within a network. The system includes a component maintenance system associated with each networked component in the network. The component maintenance system includes a self monitoring component for monitoring operation of each network component and detecting an abnormality. The component maintenance system also includes a resource location and negotiation module for querying a network to locate and negotiate for resources for compensating for the abnormality upon detection of the abnormality.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating components of an network component maintenance system in accordance with an embodiment of the invention;

FIG. 3 is a is a block diagram illustrating a computerized environment in which embodiments of the invention may be implemented;

FIG. 4 is a flow chart illustrating a process for network component maintenance in accordance with an embodiment of the invention;

FIG. 5 is a screen shot illustrating a reporting function in accordance with an embodiment of the invention;

FIG. 6 illustrates a screen shot illustrating additional details of a reporting function in accordance with an embodiment of the invention;

FIG. 7 illustrates a screen shot showing a diagnostic function in accordance with an embodiment of the invention;

FIG. 8 illustrates a screen shot illustrating a reporting function in accordance with an embodiment of the invention; and

FIG. 9 illustrates an additional screen shot showing a reporting function in accordance with an embodiment of the invention.

### DETAILED DESCRIPTION OF THE INVENTION

I. System Overview

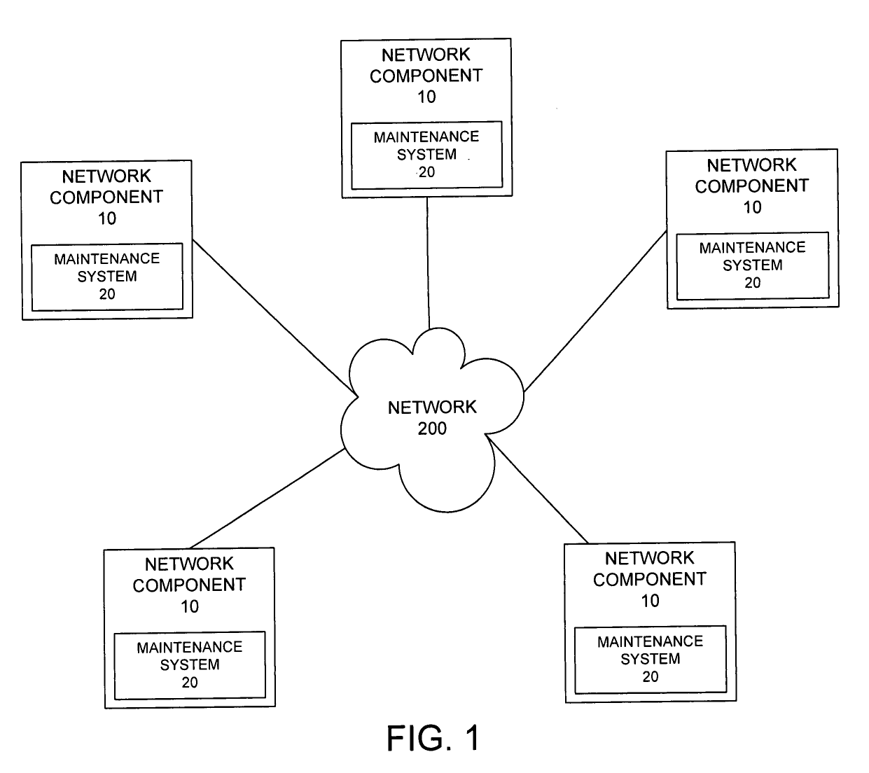

Embodiments of the invention include a method and system for maintaining individual network components in order to preserve the quality of the user experience in the face of hardware malfunctions or network outages. FIG. 1 illustrates a system in accordance with an embodiment of the invention. A system 2 includes a plurality of network components 10 connected over a network 200. Each network component 10 houses a network component maintenance system 20.

Each network component 10 may include a device such as a personal computer, a mobile phone, a tablet PC, a personal digital assistant (PDA), a mobile phone, or other devices. In embodiments of the invention, the network components are connected over a network in a peer-to-peer configuration.

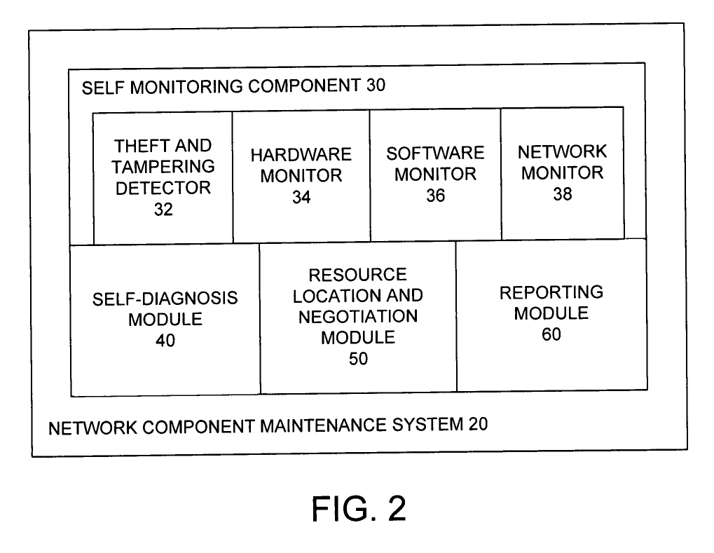

FIG. 2 illustrates components of each network component maintenance system 20 in accordance with an embodiment of the invention. The network component maintenance system 20 may include a self monitoring component 30 to assist each network component 20 with detecting abnormalities. The monitoring component 30 may include a theft and tampering detector 32, a hardware monitor 34, a software monitor 36, and a network monitor 38. The network component maintenance system 20 may also include a self-diagnosis module 40 for diagnosing problems upon detection of an abnormality. A resource location and negotiation module 50 may help to locate alternative resources over the network 200. A reporting module 60 may report abnormalities, status, and corrections to a user in order to enhance the user experience. The above-described components may include computer software components or hardware components or a combination. Each of these components will be described in further detail below.

II. Exemplary Operating Environment

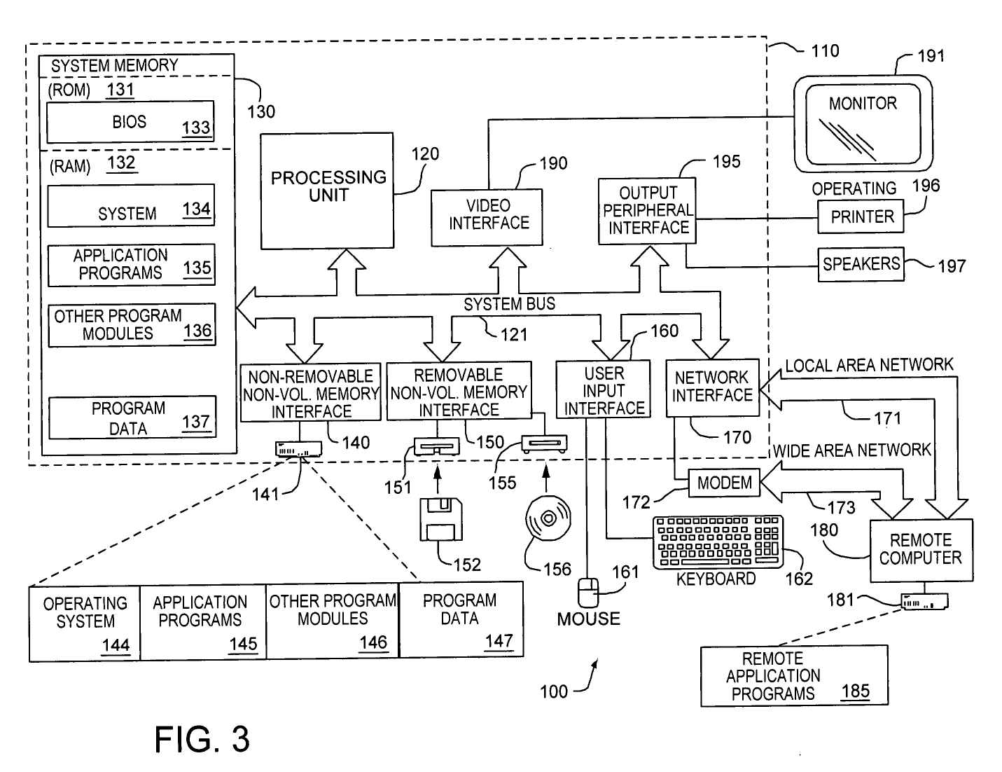

FIG. 3 illustrates an example of a suitable computing system environment 100 on which the network component maintenance system 20 may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 3, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137.

The computer 110 may also include other removable/nonremovable, volatile/nonvolatile computer storage media. By way of example only, FIG. 3 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 3, provide storage of computer readable instructions, data structures, program modules and other data for the computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 3. The logical connections depicted in FIG. 3 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 3 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 2 illustrates a network component maintenance system 20 for maintaining each component within a network and for improving the user experience. The self monitoring component 30 may be included in every device connected over the network 200. The self monitoring component 30 may be configured to detect any number of types of abnormalities.

One type of abnormality may include theft or tampering. Accordingly, a theft and tampering detector 32 monitors activities such as failed logon attempts and unauthorized or unusual activities in order to assess whether a network component 10 has been affected by theft or tampering. Another type of abnormality may include a hardware malfunction.

Accordingly, the hardware monitor tracks hardware functioning. A third type of abnormality may include software malfunctions. Thus, the software monitor 36 detects software malfunctions. Network malfunctions may also occur. The network monitor 38 is preferably incorporated in each monitoring component 30 in order to detect network malfunctions.

Upon detection of an abnormality, the self-diagnosis module 40 determines the nature of the abnormality. In an ideal situation, a detected abnormality can be corrected through the use of resources within the networked system. The network component maintenance system 20 may implement the resource location and negotiation module 50 to seek and obtain resources within the system. To respond to hardware malfunctions, the invention assumes the existence of standards that describe networked device capabilities and resources in a uniform manner. It also assumes the existence of standards that facilitate and secure automated negotiation for the purchase and sale of networked device capabilities and resources.

Whether or not necessary resources are available within the networked system, the reporting module 60 may report abnormalities to the user in order to enhance the user experience. The reporting module 60 may report abnormal events such as theft of one networked device to another networked device. To efficiently communicate the overall health of the distributed platform to the user, the platform may categorize its current health as being in one of three states using semantics that will make sense to the user. For instance, a set of anthropomorphic terms such as “happy, concerned, and upset” might work well for a user who has little technical knowledge. “Happy” would be an assumed condition (in the absence of notifications stating otherwise) indicating that the platform is operating normally with no indication of malfunction, service outages, or security issues. “Concerned” would generate low profile, non-interrupting information notifications indicating that the platform has detected malfunctions, is experiencing service outages, or has withstood a security related attack, but has found ways to respond to the problem and has preserved the user's experience. “Upset” would force an interruption to the user experience indicating malfunction, service outages, or security breaches the platform cannot overcome, forcing it to request intervention or other action from the user, or the problem may be so severe that the condition is self evident.

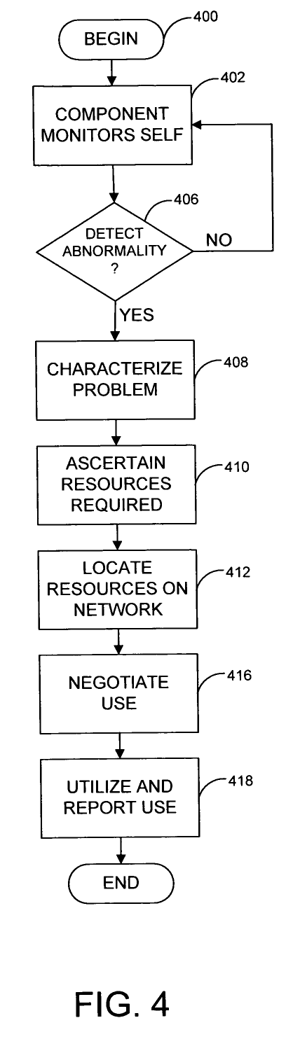

FIG. 4 illustrates a method for maintaining a network component in accordance with an embodiment of the invention. The process begins in step 400. In step 402, a normally operating network component 10 uses its component maintenance system 20 to implement its self-monitoring component to detect an abnormality. The monitoring may occur continuously within each network component. In step 406, if an abnormality is detected, the self-diagnosis module 40 characterizes the problem in relation to the quality of the user experience. In step 410, the maintenance system 20 ascertains the resources required for correction in order to preserve the user experience. In step 412, the resource location and negotiation module 50 queries the network for availability of replacement resources and negotiates for the use of those resources in step 416. Negotiation may be for temporary use within parameters previously specified that are acceptable to responsible parties. After obtaining the resources, the component utilizes the resources in step 418 and reports the situation of degraded resources to the user through the reporting module 60.

Depending upon the type of abnormality that is detected, the procedures following detection may vary. If the abnormality detected is a wired or wireless network outage, distributed platforms implementing this invention will attempt to automatically acquire alternative network services. In the event that one or more alternative network services are identified, the platform will determine the best value among the available networks based on previously identified user preferences for characteristics such as cost, performance, or security.

If the abnormality detected is a hardware outage, the reporting component 60 may report a current operational state of the network component when queried, as well as report whether or not the component is currently processing signals or receiving commands. The monitoring component 30 may monitor whether or not the hardware component externally appears to be working.

For instance, a monitoring component may include an electrical current sensor to monitor a display's driver circuitry to insure that it functions at a basic level, but could also include fine monitoring of small variations that indicate that the information rendered on the display is changing relative to an active input signal. Should the display experience a hardware failure resulting in loss of the image, the device may determine that all other features are functioning and all that is missing is the display.

As an example of a negotiation, utilizing the previously mentioned standards, the device with the malfunctioning display may query other devices or network components based on their proximity, their ability to provide a display, and at what price they might be willing to allow the malfunctioning device to temporarily rent their display. Upon a successful negotiation for rental, the malfunctioning device initiates a session over the network that carries its image data formatted in a manner that the rented device can use to provide the working display component required to complete the malfunctioning device's user interface.

If the detected abnormality is theft or tampering, security features residing in the distributed platform component at risk will at least temporarily resist a malicious attack and will detect their jeopardy through activity patterns that can be differentiated from those of the authorized user. During the period after detection of the threat but before compromise, the reporting module 60 may transmit high priority messages to the authorized user notifying the authorized user of the imminent danger. Typically, other components of the distributed platform will not be affected by the malicious activity and can therefore still render an alarm message for the user. The reporting module 60 can then assist the user in responding to the malicious activity by providing data such as the reason for the alarm condition (ie: repeated failed attempts to log-in to the component), physical location of the component (ie: as provided by an integrated GPS receiver or detection of nearby registered network segments), or by supporting remote console sessions to the device under attack. For example, in the case of a stolen mobile telephone, the authorized user could remotely control an integrated camera application and photograph the thief.

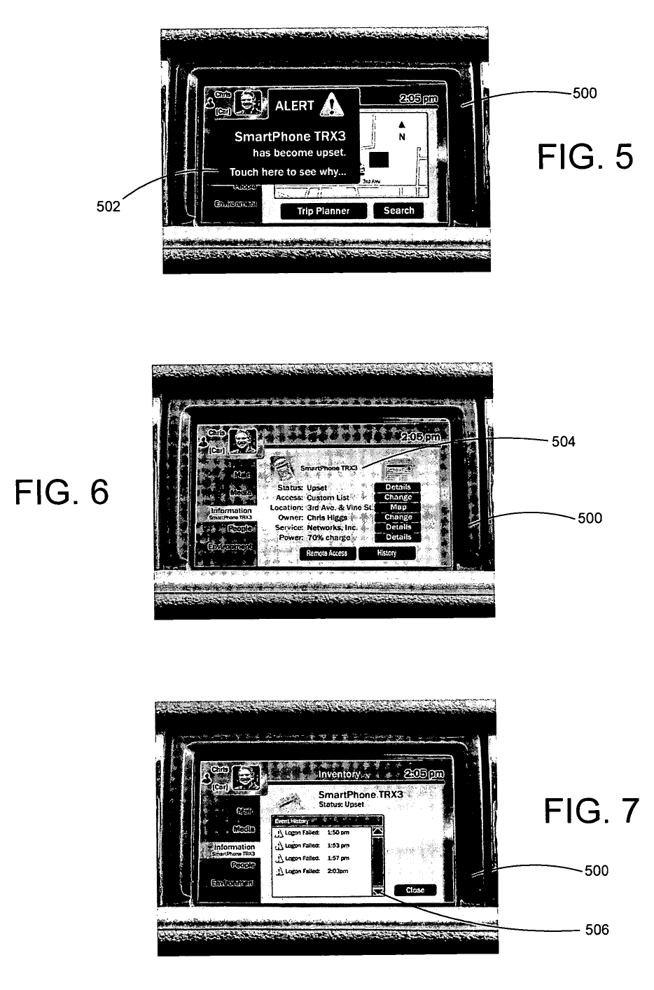

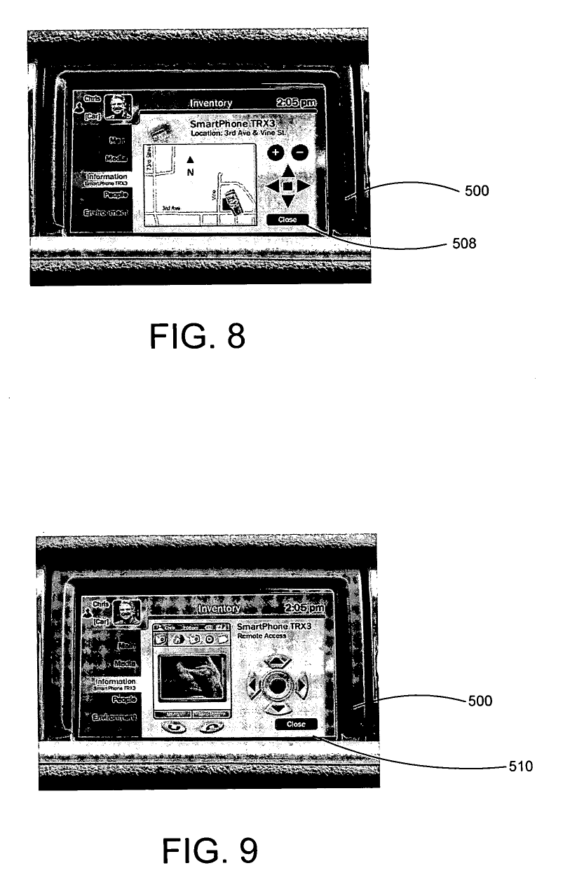

FIGS. 5-9 provide screen shots to illustrate the example of theft explained above. FIG. 5 illustrates a screen display 500 from a user's car computer. The display 500 provides an alert 502 that a connected smart phone is in an abnormal state. FIG. 6 illustrates the car computer screen 500 including a status report 504. FIG. 7 illustrates the car computer screen 500 detailing failed login attempts 506 because the failed attempts have exceeded a pre-set alarm threshold. FIG. 8 illustrates the car computer screen 500 including a phone location map 508. Finally, FIG. 9 illustrates the car computer screen 500 including a remote session 510 into the stolen phone. The remote session 510 accesses a camera application and takes a photograph of the thief. Thus, the invention also increases a user's ability to respond in the event of the physical theft of networked devices.

Furthermore, the invention provides a user interface for communicating the health of the distributed platform in a way that matches a user's needs, regardless of the user's technical understanding of the system. The invention provides methods for detecting and responding to hardware malfunction and network outages thereby increasing the system's ability to preserve the quality of the user experience in the face of hardware malfunctions or network outages.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A method for maintaining a network component, the method comprising
continuously monitoring the network component for an abnormality;
querying the network for resources upon detecting an abnormality; and
implementing alternative network resources to compensate for the abnormality in order to preserve a user experience.

2. The method of claim 1, further comprising monitoring the network component for a hardware abnormality.

3. The method of claim 1, further comprising monitoring the network component for unauthorized use.

4. The method of claim of claim 1, further comprising monitoring the network component for a software abnormality.

5. The method of claim 1, further comprising characterizing the abnormality and ascertaining resources required to compensate for the abnormality.

6. The method of claim 1, wherein utilizing alternative network resources comprises using resources of another network component.

7. The method of claim 6, further comprising negotiating for alternative network resources and providing alternative network resources offering a best value.

8. The method of claim 7, further comprising reporting the negotiated usage to the user.

9. The method of claim 1, further comprising reporting the abnormality to the user.

10. A computer readable medium storing computer executable instructions for performing the method of claim 1.

11. A network component maintenance system for preserving quality of a user experience, the maintenance system comprising:
a self monitoring component for monitoring operation of the network component and detecting an abnormality; and
a resource location and negotiation module for querying a network to locate and negotiate for resources for compensating for the abnormality upon detection of the abnormality.

12. The system of claim 11, wherein the self monitoring component comprises a theft and tampering detector.

13. The system of claim 11, wherein the self monitoring component comprises a hardware monitor for monitoring hardware abnormalities.

14. The system of claim 11, wherein the self monitoring component comprises a software monitor for monitoring for software abnormalities.

15. The system of claim 11, wherein the self monitoring component comprises a network monitor for monitoring network abnormalities.

16. The system of claim 11, further comprising a self diagnosis module for characterizing a detected abnormality.

17. The system of claim 11, further comprising a reporting module for providing a user with an abnormality report.

18. The system of claim 17, wherein the reporting module further comprises tools for providing the user with a negotiated resource report.

19. The system of claim 11, wherein the resource location and negotiation module negotiates for resources offering a best value.

20. A network maintenance system for preserving a user experience within a network, the system comprising:
a component maintenance system associated with each networked component in the network, wherein the component maintenance system comprises,
a self monitoring component for monitoring operation of each network component and detecting an abnormality; and
a resource location and negotiation module for querying a network to locate and negotiate for resources for compensating for the abnormality upon detection of the abnormality.

21. The system of claim 20, wherein the component maintenance system further comprises a self diagnosis module for characterizing a detected abnormality.

22. The system of claim 20, wherein the component maintenance system further comprises a reporting module for providing a user with an abnormality report.

23. The system of claim 22, wherein the reporting module further comprises tools for providing the user with a negotiated resource report.

24. The system of claim 20, wherein the resource location and negotiation module negotiates for resources offering a best value.
